(19) United States
(12) Patent Application Publication
(10) Pub. No.: US 2019/0366789 A1
(43) Pub. Date: Dec. 5, 2019

(54) INTEGRATED AIR SPRING FOR AN AXLE/SUSPENSION SYSTEM

(71) Applicant: Hendrickson USA, L.L.C., Itasca, IL (US)

(72) Inventors: Benedetto A. Naples, Canton, OH (US); Donald R. Hester, East Canton, OH (US)

(21) Appl. No.: 16/427,603

(22) Filed: May 31, 2019

Related U.S. Application Data
(60) Provisional application No. 62/679,440, filed on Jun. 1, 2018.

(51) Int. Cl. B60G 11/28; B60G 9/00; B60G 17/052; B60G 11/27

(52) U.S. Cl. CPC B60G 11/28; B60G 9/00; B60G 17/0525; B60G 2800/914; B60G 2202/152; B60G 2204/126; B60G 2300/026; B60G 11/27

(57) ABSTRACT

An air spring for an axle/suspension system of a heavy-duty vehicle including a bellows, a mounting bracket, and a retention collar. The mounting bracket is integrated into the heavy-duty vehicle axle/suspension system. The bellows has a bellows chamber and is operatively connected to the mounting bracket by the retention collar.

### CROSS-REFERENCE TO RELATED APPLICATION

This application claims the benefit of U.S. Provisional Patent Application No. 62/679,440, filed Jun. 1, 2018.

### BACKGROUND OF THE INVENTION

### FIELD OF THE INVENTION

The invention relates generally to the art of axle/suspension systems for heavy-duty vehicles. In particular, the present invention relates to axle/suspension systems that utilize an air spring to cushion the ride of the heavy-duty vehicle. More particularly, the present invention is directed to an air spring for an air-ride axle/suspension system of a heavy-duty vehicle that is integrated into and has a continuous volume with the beam of a suspension assembly of the axle/suspension system to provide a greater damping energy or lower spring rate and has components that are easily separable, such that the air spring is easier to service and repair and replacement of damaged components is easier, more cost effective, and does not require specialized tools or training.

### BACKGROUND ART

The use of air-ride axle/suspension systems has been very popular in the heavy-duty vehicle industry for many years. For the purposes of clarity and convenience, reference is made to a heavy-duty vehicle with the understanding that such reference includes trucks, tractor-trailers or semi-trailers, trailers, and the like. Although such axle/suspension systems can be found in widely varying structural forms, in general their structure is similar in that each system typically includes a pair of suspension assemblies. The suspension assemblies are typically connected directly to a primary frame of the heavy-duty vehicle or to a subframe supported by the primary frame. For those heavy-duty vehicles that support a subframe, the subframe can be non-movable or movable, the latter being commonly referred to as a slider box, slider subframe, slider undercarriage, secondary slider frame, or bogey.

Each suspension assembly of an axle/suspension system includes a longitudinally-extending elongated beam. Each beam typically is located adjacent to and below a respective one of a pair of spaced-apart longitudinally extending main members and one or more cross members, which form the frame of the heavy-duty vehicle. For the purpose of convenience and clarity, reference herein will be made to main members with the understanding that such reference is by way of example and includes main members of primary frames, movable subframes, and non-movable subframes. Each beam is pivotally connected at one of its ends to a hanger, which in turn is attached to and depends from a respective one of the main members of the heavy-duty vehicle. The beam may extend rearwardly or frontwardly from the pivotal connection relative to the front of the heavy-duty vehicle, thus defining what are typically referred to as trailing- or leading-arm axle/suspension systems, respectively. However, for purposes of the description contained herein, it is understood that the term trailing-arm will encompass beams which extend either rearwardly or frontwardly with respect to the front end of the heavy-duty vehicle. An axle extends transversely between and typically is connected by some means to the beams of the pair of suspension assemblies at a selected location from about the mid-point of each beam to the end of the beam opposite the pivotal connection end. An air spring, or its equivalent, is typically connected to and extends between the beam end opposite the pivotal connection end and a respective one of the main members. A height control valve is mounted on the main member or other support structure and is operatively connected to the beam and to the air spring in order to maintain the ride height of the heavy-duty vehicle. A brake system and, optionally, one or more shock absorbers are also mounted on the axle/suspension system.

The axle/suspension system acts to cushion the ride, damp vibrations, and stabilize the heavy-duty vehicle. More particularly, as the heavy-duty vehicle is traveling over the road, the wheels of the heavy-duty vehicle encounter road conditions that impart various forces, loads, and/or stresses, collectively referred to herein as forces, to the respective axle on which the wheels are mounted, and in turn, to the suspension assemblies that are connected to and support the axle. These forces include vertical forces caused by vertical movement of the wheels as they encounter certain road conditions, fore-aft forces caused by acceleration and deceleration of the heavy-duty vehicle and certain road conditions, and side-load and torsional forces associated with transverse heavy-duty vehicle movement, such as turning and lane-change maneuvers.

In order to minimize the detrimental effect of these forces on the heavy-duty vehicle as it is operating, the axle/suspension system is designed to react and/or absorb at least some of them. In particular, the axle/suspension systems are designed with structural characteristics to address these disparate forces. More particularly, it is desirable for an axle/suspension system to have beams that are fairly stiff in order to minimize the amount of sway experienced by the heavy-duty vehicle, and thus provide roll stability, as is known. However, it is also desirable for an axle/suspension system to be relatively flexible to assist in cushioning the heavy-duty vehicle from vertical impacts and provide the axle/suspension system with compliance to resist failure and increase durability. Moreover, it is desirable to damp the vibrations or oscillations that may result from these forces.

A key component of the axle/suspension system that cushions the ride of the heavy-duty vehicle from vertical impacts is the air spring. In the past, shock absorbers were utilized on the axle/suspension system to provide damping characteristics to the axle/suspension system. More recently, air springs with damping characteristics have been developed that provide damping to the axle/suspension system, thereby reducing or eliminating the need for shock absorbers. One such air spring with damping characteristics is shown and described in U.S. Pat. No. 8,540,222, and assigned to the Applicant of the instant application, Hendrickson USA, L.L.C.

Air springs of the type utilized in heavy-duty vehicle air-ride axle/suspension systems include three main components: a flexible bellows, a bellows top plate, and a piston. The bellows is typically formed from rubber or other flexible material and is sealingly engaged with the bellows top plate and also the top portion of the piston. The volume of pressurized air, or “air volume”, that is contained within the air spring is a major factor in determining the spring rate, or stiffness, of the air spring. More specifically, this air volume is contained within the bellows and, in some cases, the piston of the air spring. For non-damping air springs, the greater the air volume of the air spring, the lower the spring rate, or stiffness, of the air spring. A lower spring rate, or reduced stiffness, is generally more desirable in the heavy-duty vehicle industry because it decreases vibration transmitted to the frame of the heavy-duty vehicle, allowing for softer ride characteristics. For damping air springs, the greater the internal volume of the piston, the greater the damping energy of the air spring. A greater damping energy is generally more desirable because it results in fewer unmitigated vibrational frequencies.

Air spring bellows for both damping and non-damping air springs must maintain an airtight seal in order to function normally and support the loads placed upon them. Prior art air springs generally use a snap-on or clamping design to ensure an airtight seal between the bellows and other components, such as the piston. A snap-on type prior art air spring seal typically consists of a lower rim of the bellows drawn up under a lip formed about the piston. The internal air pressure in addition to the capture of the bellows lower end by the lip of the piston provides sufficient force, under most operational conditions, to maintain an air-tight seal. A clamped prior art air spring seal has the lower rim of the bellows drawn up over the piston. An additional clamping plate is placed over the bellows lower rim. The pressure created by the volume of air within the bellows chamber presses the clamping plate into the bellows lower rim and piston, thereby trapping the bellows lower rim between the clamping plate and the piston. The clamping plate may also be secured by a secondary fastener such as a central bolt or screw passed through the clamping plate and into the piston allowing the clamping plate to be compressed against the piston.

Typically, the piston of the air spring either contains a hollow cavity, which adds to the air volume of the air spring by providing communication of air between the piston and the bellows volumes, or has a generally hollow cylindrical-shape, which does not communicate with the bellows volume or contribute to the air volume of the air spring. In the event the piston adds to the air volume of the air spring, the air volume of the piston may alter the damping energy of damping air springs or the spring constant of non-damping air springs. In any event, the air volume of the air spring is in fluid communication with an air source, such as an air supply tank, and also is in fluid communication with the height control valve of the heavy-duty vehicle. The height control valve, by directing air flow into and out of the air spring of the axle/suspension system, helps maintain the desired ride height of the heavy-duty vehicle.

Prior art air springs, while satisfactory for their intended purpose, have certain potential disadvantages, drawbacks, and limitations. For example, prior art air springs that utilize the snap-on design rely on the air pressure within the bellows chamber to maintain a sufficient downward force on the lower rim of the bellows so that the bellows and air spring remain together. During operation, the pressure within the bellows chamber may change due to extreme jounce events, in which the air spring is quickly compressed, creating very-high pressure that may overcome the ability of the lip to prevent the lower rim of the bellows from detaching, resulting in the bellows blowing out. In addition, when the piston is pulled away from the bellows, such as during an extreme rebound event, the pressure in the air spring may be insufficient to prevent the lower rim of the bellows from detaching.

Moreover, prior art air springs utilizing a clamping design with secondary fasteners, although generally more secure, require additional hardware which adds weight and complexity to the air spring and the axle/suspension system. This increased complexity makes prior art air springs more difficult to service, leading to a need for greater technical skill and increased time to complete repairs or replacements. As a result, entire prior art air springs are typically replaced when the bellows is damaged or fails, thereby increasing the cost of operation and repair.

Furthermore, the piston of the prior art air damping and non-damping air springs has a relatively limited internal volume, which tends to reduce the damping energy of the damping air springs and tends to increase the spring constant, or stiffness, of the non-damping air spring, which may lead to increased vibration. Increased vibration can potentially cause vehicle operation problems, increasing maintenance, operational costs, and downtime of the heavy-duty vehicle.

The present invention overcomes the disadvantages, drawbacks, and limitations associated with prior art air spring designs by providing an air spring with a replaceable bellows removably connected to a secondary volume or reservoir integrated into the heavy-duty vehicle axle/suspension system, allowing for the air spring to be easily disassembled for servicing and component replacement. Additionally, the secondary volume increases the volume of the piston and air spring, thereby increasing the damping energy and/or lowering the spring rate of the air spring.

### SUMMARY OF THE INVENTION

Objectives of the present invention include providing an air spring with a removable bellows that allows for the air spring to be easily disassembled and the bellows replaced without specialized skills or tools.

A further objective of the present invention is to provide an air spring with increased damping energy and/or decreased spring rate, or stiffness, of the air spring.

These objectives and advantages are obtained by the air spring for an axle/suspension system of a heavy-duty vehicle including a bellows, a mounting bracket, and a retention collar. The mounting bracket is integrated into the heavy-duty vehicle axle/suspension system. The bellows has a bellows chamber and is operatively connected to the mounting bracket by the retention collar.

### BRIEF DESCRIPTION OF THE SEVERAL VIEWS OF THE DRAWINGS

The preferred embodiment of the present invention, illustrative of the best mode in which applicant has contemplated applying the principles, is set forth in the following description, shown in the drawings, and particularly and distinctly pointed out and set forth in the appended claims.

FIG. 1 is a top rear perspective view of a prior art air heavy-duty vehicle axle/suspension system incorporating a pair of prior art air springs mounted on respective suspension assemblies;

FIG. 2 is a perspective view, in section, of a prior art air spring, showing a bellows sealed by a snap-on design;

FIG. 3 is a perspective view, in section, of another prior art air spring, showing a bellows sealed by clamping;

FIG. 4 is a fragmentary exploded elevational view of an exemplary embodiment air spring of the present invention with removable bellows, showing the air spring integrally formed with the beam of the axle/suspension system; and

FIG. 5 is an elevational view, in section, of the exemplary embodiment air spring shown in FIG. 4.

Similar reference characters identify similar parts throughout.

### DESCRIPTION OF THE PREFERRED EMBODIMENT

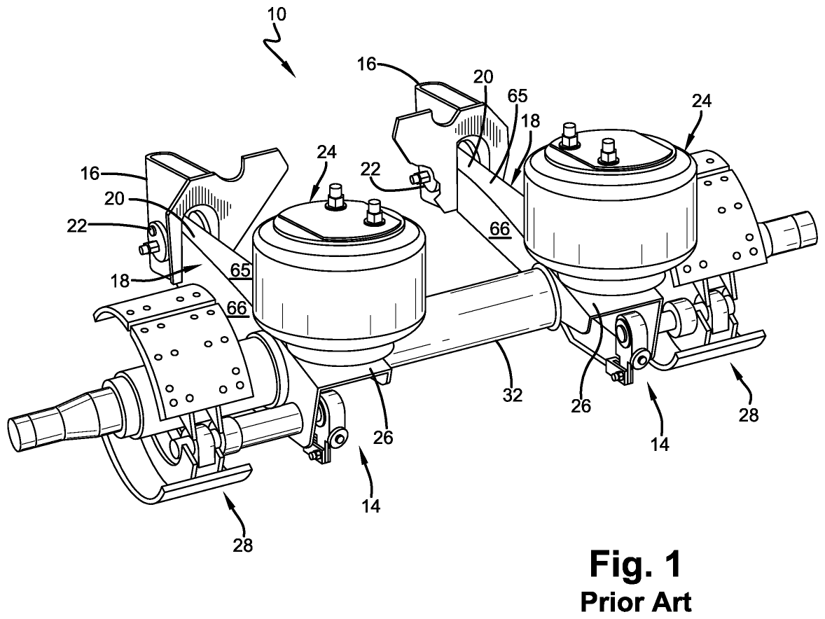

In order to better understand the environment in which the air spring for heavy-duty vehicles of the present invention is utilized, an air-ride axle/suspension system 10 incorporating a pair of prior art heavy-duty vehicle air springs 24 is shown in FIG. 1. It should be noted that axle/suspension system 10 typically includes a pair of mirror-image suspension assemblies 14, each suspended from a respective longitudinally-extending spaced-apart main member (not shown) of a heavy-duty vehicle (not shown). Because suspension assemblies 14 are mirror-images, for the purposes of clarity and conciseness, only one of the suspension assemblies will be described below.

Suspension assembly 14 includes a beam 18 pivotally connected to a hanger 16, which is mounted on the main member (not shown) of the heavy-duty vehicle. In particular, beam 18 is formed having a generally upside-down integrally formed U-shape with a pair of sidewalls 66 and a top plate 65, with the open portion of the beam facing generally downwardly. A bottom plate (not shown) extends between and is attached to the lowermost ends of sidewalls 66 by any suitable means, such as welds, to complete the structure of beam 18. Beam 18 includes a front end 20 having a pivot connection 22 to facilitate pivotal connection of the beam to hanger 16. An axle 32 extends between and is captured by beam 18. Suspension assembly 14 also includes prior art air spring 24, which is mounted on and extends between a rear end 26 of beam 18 and the main member (not shown) of the heavy-duty vehicle. For the sake of relative completeness, a brake system 28 is shown mounted on suspension assembly 14.

As mentioned above, axle/suspension system 10 is designed to absorb and/or react forces that act on the heavy-duty vehicle during operation. More particularly, it is desirable for axle/suspension system 10 to resist roll forces, and thus provide roll stability, for the heavy-duty vehicle. This is typically accomplished by using beam 18, which is rigid, and is rigidly attached to axle 32. It is also desirable, however, for axle/suspension system 10 to be flexible to assist in cushioning the heavy-duty vehicle from vertical impacts and to provide the axle/suspension system with compliance to resist failure. Such flexibility typically is achieved through a bushing (not shown) at pivot connection 22. Air spring 24 also assists in cushioning and/or controlling the ride for cargo and/or passengers.

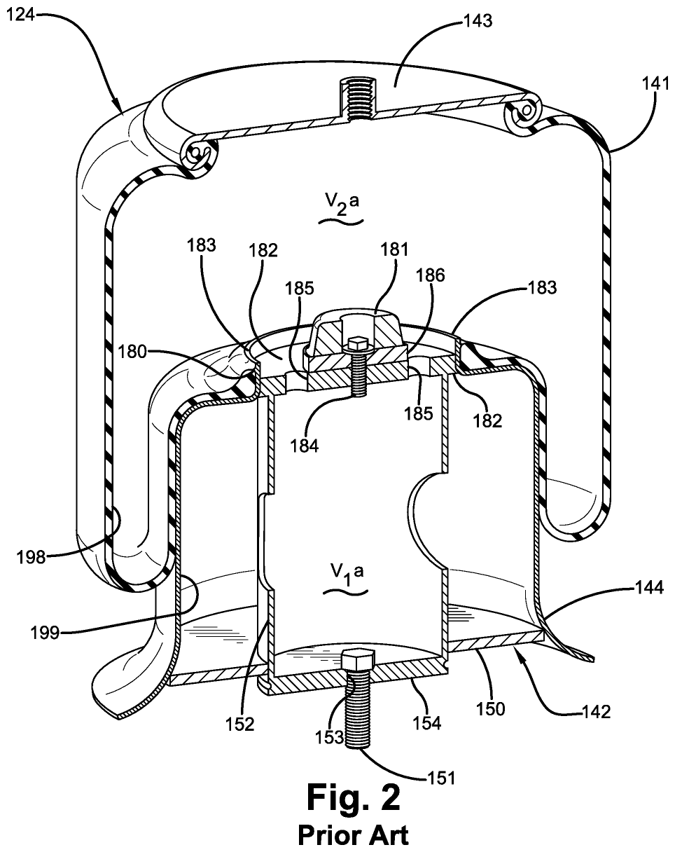

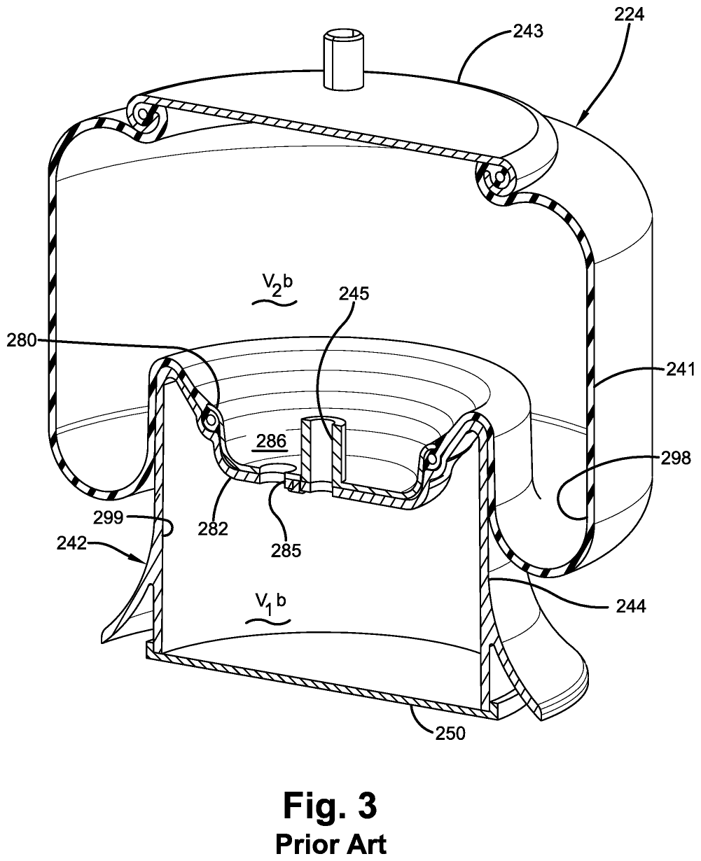

Prior art air spring 24 shown in FIG. 1 is an air spring of the damping type similar to prior art air springs 124, 224 shown in FIGS. 2 and 3, respectively, which will each be described in detail below.

With particular reference to FIG. 2, air spring 124 is typically incorporated into any air-ride axle/suspension system, such as axle/suspension system 10. Air spring 124 includes a top plate 143, a bellows 141, and a piston 142. Piston 142 is generally cylindrical and includes a continuous generally stepped sidewall 144 attached to a generally flat bottom plate 150 and an integrally formed top plate 182. Bottom plate 150 is formed with an upwardly extending central hub 152. Central hub 152 includes a bottom plate 154 formed with a central opening 153. A fastener 151 is disposed through opening 153 in order to attach piston 142 to beam top plate 65 at beam rear end 26. Bottom plate 150, sidewall 144, and top plate 182 of piston 142 define a piston chamber 199 having an internal volume V₁a.

Top plate 182 of piston 142 is formed with a circular upwardly extending protrusion 183 having a lip 180 formed about its circumference. Lip 180 cooperates with the lowermost end of bellows 141 to form an airtight seal between the bellows and the lip, and is known in the art as a snap-on design. Bellows 141, top plate 143, and piston top plate 182 define a bellows chamber 198 having an internal volume V₂a. Top plate 182 is formed with a pair of circular-shaped openings 185, which allow piston chamber volume V₁a and bellows chamber volume V₂a to communicate with one another. More particularly, openings 185 allow fluid or air to pass between piston chamber 199 and bellows chamber 198 during operation of the heavy-duty vehicle.

A bumper mounting plate 186 is mounted on piston top plate 182 by a fastener 184. A bumper 181 is rigidly attached to bumper mounting plate 186 in a well-known manner. Bumper 181 extends upwardly from the top surface of bumper mounting plate 186. Bumper 181 serves as a cushion to prevent contact between piston top plate 182 and bellows top plate 143, which can potentially cause damage to the plates and air spring 124 during air loss or extreme jounce events during operation of the heavy-duty vehicle.

Prior art air spring 124, while satisfactory for the intended purpose, has certain potential disadvantages, drawbacks, and limitations. For example, prior art air spring 124 relies on the air pressure within bellows chamber 198 to maintain a sufficient downward force on the lowermost portion of the bellows 141 to form an airtight seal between the bellows and piston 142. During operation, bellows chamber volume V₂a may become compressed during extreme jounce events, increasing the pressure within bellows chamber 198. In the event the bellows 141 is not properly seated, the increase in pressure within bellows chamber 198 may potentially cause the bellows to be dislodged. In addition, during an extreme rebound event, piston 142 may be pulled away from bellows 141, such that the pressure in bellows chamber 198 may be insufficient to prevent the lowermost portion of the bellows from potentially detaching. Moreover, piston volume V₁a is of relatively limited size, thereby limiting the damping energy of prior art air spring 124, which may result in increased vibration, potentially causing operational problems, and potentially increasing maintenance, operational costs, and heavy-duty vehicle downtime.

Prior art air spring 224 (FIG. 3) is also typically incorporated into any air-ride axle/suspension system, such as axle/suspension system 10. Prior art air spring 224 is similar in construction and arrangement to prior art air spring 124 (FIG. 2). As a result, the description below will be primarily directed to the differences between prior art air spring 124 and prior art air spring 224.

Prior art air spring 224 includes a top plate 243, a bellows 241, and a piston 242. Piston 242 is generally cylindrical and includes a sidewall 244 connected to a top plate 282 and a bottom plate 250. Top plate 282, sidewall 244, and bottom plate 250 define a piston chamber 299 having an internal volume V₁b. Bellows 241, top plate 243, and piston top plate 282 define a bellows chamber 298 with an internal volume V₂b. Prior art air spring 224 utilizes a “molded-in” or clamping design end closure to connect the bellows 241 to the piston 242. In particular, a retaining plate 286 includes a flared end 280 that is molded into the lower end of bellows 241. Retaining plate 286 attaches bellows 241 to piston top plate 282 by a fastener (not shown) disposed through a central opening 245 that compresses the bellows and holds the bellows in place on piston 242 to form an airtight seal between the bellows and the piston. An opening 285 is formed through piston top plate 282 and retaining plate 286 to provide restricted fluid communication between bellows chamber 289 and piston chamber 299 during heavy-duty vehicle operation.

Prior art air spring 224, while satisfactory for the intended purpose, has certain potential disadvantages, drawbacks, and limitations. For example, prior art air spring 224, with a secondary fastener (not shown) to secure retaining plate 286 to piston top plate 282, is relatively heavier and more complex, increasing the weight of the axle/suspension system. As a result, prior art air spring 224 is more difficult to service, requiring greater technical skill and/or specialized tools and increased time and cost for maintenance and repairs. Furthermore, piston volume V₁b is of relatively limited size, thereby limiting the damping energy of prior art air spring 224, which may result in increased vibration, potentially causing operational problems, and potentially increasing maintenance, operational costs, and heavy-duty vehicle downtime.

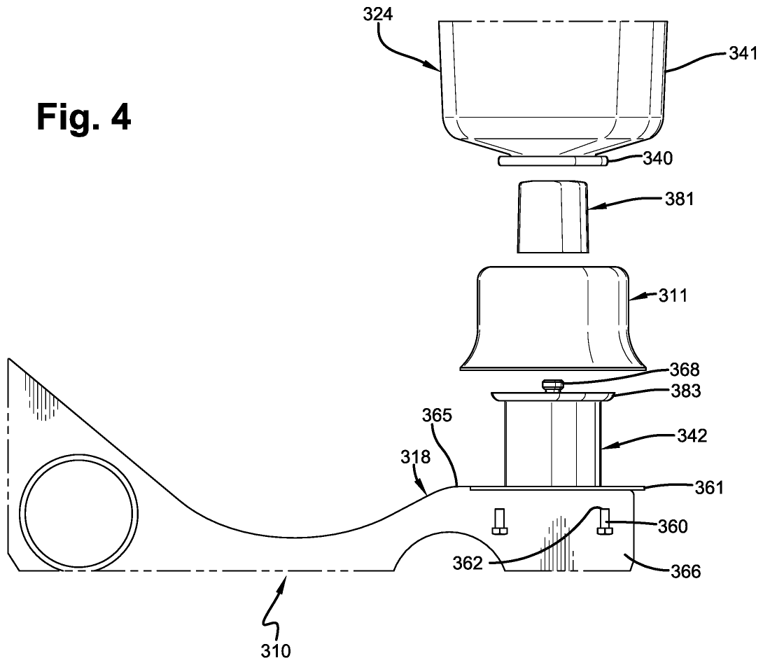

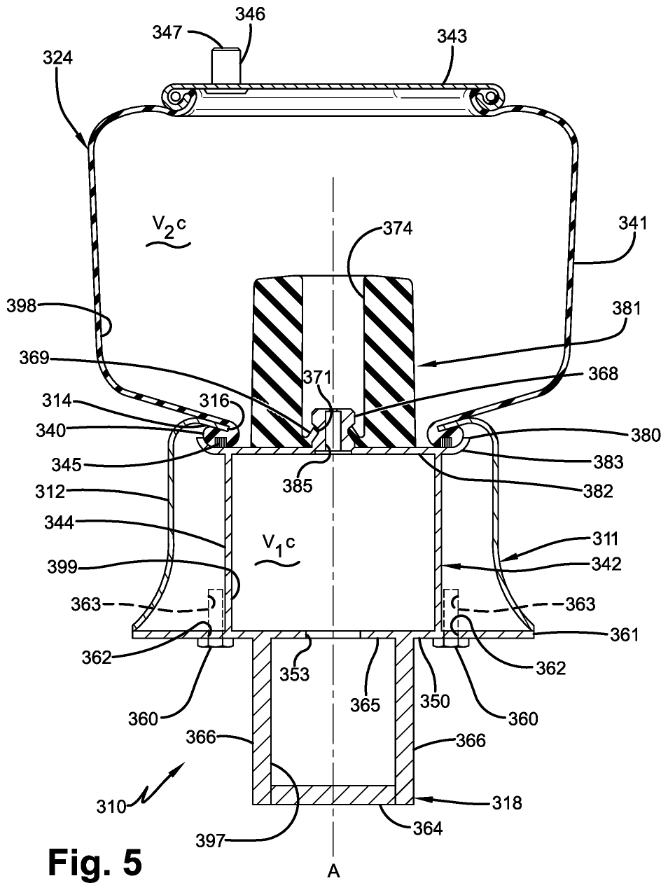

An exemplary embodiment integrated air spring 324 of the present invention is shown in FIGS. 4 and 5 and will now be described in detail below. Air spring 324 may be utilized with any air-ride axle/suspension system, such as an axle/suspension system 310. Axle/suspension system 310 is generally similar to axle/suspension system 10 described above. Air spring 324 includes a bellows 341, a top plate 343, a piston or mounting bracket 342, a longitudinal central axis A (FIG. 5), and a retention collar 311. The top end of bellows 341 is sealingly engaged with top plate 343 in a well-known manner. A fastener or inlet 346 is disposed in top plate 343 and includes an opening 347 that is in fluid communication with a height control valve (not shown) and a reservoir or air tank (not shown). In addition, air spring 324 may be mounted directly or indirectly to a main member (not shown) of a heavy-duty vehicle (not shown), as is known.

With particular reference to FIG. 5, bellows 341 is generally cylindrical with respect to longitudinal central axis A. Bellows 341 includes a lower rim 340 extending radially outwardly from the bellows about the longitudinal central axis A. A support element 345 may be enveloped, embedded, or molded into bellows lower rim 340 to provide stability and stiffness to the lower rim and to provide sufficient structure for forming an air tight seal as described in detail below. Support element 345 may be formed from any suitable material into any suitable size or shape, such as a ring or hoop or one or more small spheres or beads. It is also contemplated that support element 345 may be magnetic or non-magnetic.

Mounting bracket 342 is integrally formed with and projects perpendicularly from a top plate 365 of a beam 318 (only a portion shown) of axle/suspension system 310 (only a portion shown). In particular, a bottom plate 350 of mounting bracket 342 is formed continuously with beam top plate 365. Alternatively, mounting bracket 342 may be formed completely within beam 318, may extend in any other direction from beam 318, and/or may be integrated into any other portion or part of axle/suspension system 310 or member of the heavy-duty vehicle. Mounting bracket 342 has a generally cylindrical sidewall 344 attached to and extending between a top plate 382 and bottom plate 350. Alternatively, mounting bracket 342 may be formed with any other suitable shape or orientation. Bottom plate 350 is formed with a collar flange 361 that extends radially outward from the interface between the bottom plate and sidewall 344 about longitudinal central axis A. As a result, collar flange 361 and bottom plate 350 are co-planar. Alternatively, collar flange 361 may be coplanar with a bottom plate 364 (FIG. 5) of beam 318 or may extend outwardly from sidewalls 366 of the beam. One or more openings 362 are formed in collar flange 361 and extend through the collar flange to receive a respective number of fasteners 360 therethrough.

Sidewall 344, top plate 382, and bottom plate 350 define a mounting bracket chamber 399 with an internal volume V₁c. Piston top plate 382, bellows 341, and the bellows top plate define a bellows chamber 398 with an internal volume V₂c. Beam 318 of axle/suspension system 10 is at least partially hollow, such that the beam has a beam chamber 397 formed therein. Mounting bracket chamber volume V₁c is generally continuous between beam chamber 397 and mounting bracket chamber 399. In particular, bottom plate 350 has an opening 353 that provides fluid communication between mounting bracket chamber 399 and beam chamber 397. In addition, mounting bracket chamber 399 is also in fluid communication with bellows chamber 398. More specifically, top plate 382 is formed with a central opening 385, which provides fluid communication between bellows chamber 398 and mounting bracket chamber 399. Openings 353, 385 may be any size or shape, such that the openings may provide restricted or unrestricted fluid communication between mounting bracket chamber 399, beam chamber 397, and bellows chamber 398. As a result, beam chamber 397, may provide mounting bracket 342 and/or air spring 324 with a larger volume, thereby increasing the damping energy or reducing the spring constant of air spring 324.

Mounting bracket 342 also includes a projection 368 and a bumper 381. Projection 368 is formed about opening 385 and extends from mounting bracket top plate 382 into bellows chamber 398. Projection 368 may be conical or frustoconical in shape. An annular relief 371 is formed in the external surface of projection 368 about longitudinal central axis A. Opening 385 and projection 368 may function together to restrict fluid communication between bellows chamber 398 and mounting bracket chamber 399, thereby providing damping to air spring 324. Bumper 381 is generally cylindrical and mounted or removably attached to top plate 382. Bumper 381 is formed with a central opening 374 through the bumper. Bumper 381 is disposed such that opening 374 is concentric with mounting bracket opening 385. Projection 368 extends into opening 374, such that bumper 381 is disposed about the projection. An annular projection 369 extends radially inward from bumper 381 about longitudinal central axis A. Annular projection 369 may also be formed, such that the annular projection extends at least partially parallel to longitudinal central axis A. As a result annular projection 369 may be angled toward or away from top plate 382. Annular projection 369 operatively engages annular relief 371 on projection 368, such that the annular projection is at least partially captured or retained by the annular relief, securing bumper 381 to top plate 382.

In accordance with an important aspect of the present invention, mounting bracket 342 includes a bellows flange 383, which extends radially outward from the interface between mounting bracket top plate 382 and sidewall 344 about longitudinal central axis A, such that the bellows flange and the top plate are co-planar. It is also contemplated that bellows flange 383 may not be co-planar with top plate 382, such that the bellows flange may extend radially outward from anywhere on mounting bracket 342 about longitudinal central axis A or may be coplanar with beam top plate 365. Bellows flange 383 includes a lip 380, which extends radially upwardly at an angle from the bellows flange. Bellows lower rim 340 is received on bellows flange 383 radially inwardly of lip 380, such that the lip aligns the bellows lower rim 340 as it is seated upon the bellows flange. It is also contemplated that bellows lower rim 340 may extend radially inward from bellows 341 about and toward longitudinal central axis A. In this configuration, bellows lower rim 340 may engage beneath and about bellows flange 383. Alternatively, mounting bracket 342 may not include bellows flange 383.

In accordance with another important aspect of the present invention, retention collar 311 of air spring 324 is formed with a generally cylindrical and partially stepped sidewall 312 along which bellows 341 can roll supportedly. Retention collar 311 is disposed about bellows lower rim 340 and mounting bracket 342, such that the retention collar is centered about longitudinal central axis A and spaced a distance from bellows flange 383. Retention collar 311 is formed with a flange or rim 314 extending radially inward toward longitudinal central axis A, such that the rim is angled toward beam 18. Rim 314 defines an opening 316. Opening 316 allows bellows lower rim 340 to pass therethrough. Rim 314 captures bellows lower rim 340 against bellows flange 383 to create an air tight seal. Retention collar 311 also includes one or more fastener openings 363 formed therein. The fastener openings 363 align with openings 362 on collar flange 361 to receive fasteners 360. The fastener openings may be threaded, such that once fasteners 360 are received in the fastener openings, the fasteners can be tightened, securing retention collar 311 to collar flange 361 and sealing bellows lower rim 340 against bellows flange 383. Alternatively, retention collar 311 may form one or more projections that align with and extend through openings 362 of collar flange 361. The one or more projections may be threaded to receive any suitable fastening means, such as nuts to secure retention collar 311 to collar flange 361 and seal bellows lower rim 340 against bellows flange 383.

Exemplary embodiment air spring 324 for heavy-duty vehicles, according to the present invention, overcomes the disadvantages, drawbacks, and limitations associated with prior art air springs by providing an air spring with an easily removable bellows 341. Removal of bellows 341 can be performed, such that repair or replacement does not involve specialized tools or skills, minimizing heavy-duty vehicle downtime. For example, in order to easily remove bellows 341, fasteners 360 are removed from retention collar 311 and the retention collar is removed from mounting bracket 342. This frees bellows lower rim 340 from mounting bracket 342 and retention collar 311, so that the lower portion of bellows 341 can be easily removed from the mounting bracket. Fastener 346 is then removed and bellows 341 is able to be easily replaced. In addition, air spring 324 does not require additional hardware to secure bellows 341 to mounting bracket 342, thereby reducing the weight of the axle/suspension system. Exemplary embodiment air spring 324 of the present invention also provides an air spring with bellows 341 mounted directly to beam 18 or another component of the axle/suspension system, increasing the volume of mounting bracket 342 or the air spring and allowing for relatively greater damping energy in damping air springs or a lower spring constant in non-damping air springs.

It is contemplated that exemplary embodiment air spring 324 of the present invention could be formed from various materials, including but not limited to metal, composites, and the like, without changing the overall concept or operation of the present invention. It is also contemplated that preferred embodiment air spring 324 of the present invention could be utilized with all types of damping or non-damping air springs without changing the overall concept or operation of the present invention.

It is contemplated that exemplary embodiment air spring 324 of the present invention could be utilized on heavy-duty vehicles having one or more than one axles without changing the overall concept or operation of the present invention. It is also contemplated that exemplary embodiment air spring 324 could be utilized on heavy-duty vehicles having frames or subframes which are moveable or non-moveable without changing the overall concept of the present invention. It is further contemplated that exemplary embodiment air spring 324 could be utilized on all types of mechanical spring axle/suspension systems and air-ride axle/suspension systems, including axle/suspension systems having overslung/top-mount or underslung/bottom-mount configurations and other types of air-ride rigid beam-type axle/suspension systems, such as those using U-bolts, U-bolt brackets/axle seats, and the like, known to those skilled in the art, without changing the overall concept or operation of the present invention.

In the foregoing description, certain terms have been used for brevity, clearness, and understanding, but no unnecessary limitations are to be implied therefrom beyond the requirements of the prior art, because such terms are used for descriptive purposes and are intended to be broadly construed.

The present invention has been described with reference to a specific embodiment. It is to be understood that this illustration and description is by way of example and not by way of limitation. Potential modifications and alterations will occur to others upon a reading and understanding of this disclosure, and it is understood that the invention includes all such modifications, alterations, and equivalents thereof.

Accordingly, the air spring of the present invention is simplified, provides an effective, safe, inexpensive, and efficient structure and method, which achieve all the enumerated objectives, provides for eliminating difficulties encountered with prior art air springs, and solves problems and obtains new results in the art.

Having now described the features, discoveries, and principles of the invention; the manner in which the air spring is used and installed; the characteristics of the construction, arrangement, and method steps; and the advantageous, new, and useful results obtained, the new and useful structures, devices, elements, arrangements, process, parts, and combinations are set forth in the appended claims.

What is claimed is:

1. An air spring for an axle/suspension system of a heavy-duty vehicle comprising:
a bellows including a bellows chamber;
a mounting bracket, said mounting bracket being integrated into the heavy-duty vehicle axle/suspension system; and
a retention collar, wherein the bellows is operatively connected to the mounting bracket by the retention collar.

2. The air spring for an axle/suspension system of a heavy-duty vehicle of claim 1, the mounting bracket further comprising a reservoir volume continuous with an internal volume of a component of said axle/suspension system;

3. The air spring for an axle/suspension system of a heavy-duty vehicle of claim 2 further comprising a means for providing restricted fluid communication between the reservoir chamber and the bellows chamber;
wherein the means for providing restricted fluid communication provides damping characteristics to the axle/suspension system of the heavy-duty vehicle.

4. The air spring for an axle/suspension system of a heavy-duty vehicle of claim 3 wherein the means for providing restricted fluid communication is integrated into the mounting bracket.

5. The air spring for an axle/suspension system of a heavy-duty vehicle of claim 4 further comprising a bumper disposed within the bellows chamber about the means for providing restricted fluid communication.

6. The air spring for an axle/suspension system of a heavy-duty vehicle of claim 5, the bumper further comprising at least one annular projection;
wherein the at least one annular projection operatively retains the bumper on the mounting bracket.

7. The air spring for a heavy-duty vehicle axle/suspension of claim 1, the bellows further comprising a lower rim.

8. The air spring for a heavy-duty vehicle axle/suspension of claim 7, the mounting bracket further comprising a radially outwardly extending flange.

9. The air spring for a heavy-duty vehicle axle/suspension of claim 8, the retention collar further comprising a radially inwardly extending lip.

10. The air spring for a heavy-duty vehicle axle/suspension of claim 8, the bellows lower rim being engaged between the flange of the mounting bracket and the lip of the retention collar.

11. The air spring for a heavy-duty vehicle axle/suspension of claim 7, the bellows lower rim further comprising an internal stabilizing structure.

12. The air spring for a heavy-duty vehicle axle/suspension of claim 1, the retention collar being removably connected to a component of the heavy-duty vehicle axle/suspension system.
